(19) United States
(12) Patent Application Publication
(10) Pub. No.: US 2006/0244872 A1
(43) Pub. Date: Nov. 2, 2006

(54) Display device

(75) Inventors: Hyoung-Joo Kim, Uiwang-si (KR); In-Sun Hwang, Suwon-si (KR); Byung-Ki Kim, Gunpo-si (KR); Sang-Yu Lee, Yongin-si (KR); Jin-Seob Byun, Seoul (KR); Jae-Young Choi, Suwon-si (KR); Hae-Il Park, Seoul (KR); Myong-Hi Rhee, Seoul (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd.

(21) Appl. No.: 11/336,571

(22) Filed: Jan. 19, 2006

(30) Foreign Application Priority Data
Apr. 27, 2005 (KR) 2005-35137

(51) Int. Cl. G02F 1/135

(52) U.S. Cl. 349/25

(57) ABSTRACT

A display device includes a visible light reflecting layer and a fluorescent layer. The visible light reflecting layer transmits an invisible light. The visible light is reflected from the visible light reflecting layer. The fluorescent layer is on the visible light reflecting layer to generate a visible light in response to the invisible light that has passed through the visible light reflecting layer. The fluorescent layer transmits the visible light reflected from the visible light reflecting layer. Therefore, a manufacturing cost is decreased, and an efficiency of light is improved.

### CROSS REFERENCE TO RELATED APPLICATION

The present application claims priority from Korean Patent Application No. 2005-35137, filed on Apr. 27, 2005, the disclosure of which is hereby incorporated herein by reference in its entirety.

### BACKGROUND OF THE INVENTION

1. Field of the Invention

The present invention relates to a display device. More particularly, the present invention relates to a display device capable of decreasing manufacturing costs and improving efficiency.

2. Description of the Related Art

In a photoluminescent liquid crystal display (PLLCD) device, an ultraviolet light or a bluish light that is generated from a light source and controlled by a liquid crystal layer is irradiated onto a fluorescent layer so that a visible light is generated from the fluorescent layer, thereby displaying an image. The ultraviolet light and the bluish light have relatively short wavelengths. The PLLCD device is typically used for a small, medium, and large screened display devices. The PLLCD device has various advantageous characteristics such as wide viewing angle, high light transmittance, etc.

The visible light exits from the fluorescent layer in various directions, and is scattered by molecules in the fluorescent layer. Therefore, about 60% to about 70% of the visible light generated from the fluorescent layer is irradiated onto a display panel so that luminance and resolution of the PLLCD are decreased, and contrast ratio of the PLLCD is deteriorated.

### SUMMARY

In accordance with the present invention, a display device capable of decreasing manufacturing cost and improving efficiency is provided.

A display device in accordance with one aspect of the present invention includes a visible light reflecting layer and a fluorescent layer. The visible light reflecting layer transmits invisible light. Visible light is reflected from the visible light reflecting layer. The fluorescent layer is provided on the visible light reflecting layer to generate visible light in response to absorption of invisible light that has passed through the visible light reflecting layer. The fluorescent layer transmits the visible light reflected from the visible light reflecting layer.

A display device in accordance with another aspect of the present invention includes a light source, a visible light reflecting layer, and a fluorescent layer. The visible light reflecting layer is provided on the light source to transmit invisible light. Visible light is reflected from the visible light reflecting layer. The fluorescent layer is provided on the visible light reflecting layer to generate visible light in response to absorption of invisible light that has passed through the visible light reflecting layer. The fluorescent layer transmits the visible light reflected from the visible light reflecting layer.

A display device in accordance with still another aspect of the present invention includes a light source, a first substrate, a second substrate, a visible light reflecting layer, and a color fluorescent layer. The first substrate is provided on the light source. The second substrate corresponds to the first substrate. The visible light reflecting layer is provided on the second substrate for transmitting invisible light and reflecting visible light. The color fluorescent layer is on the visible light reflecting layer to generate visible light in response to absorption of invisible light that has passed through the visible light reflecting layer. The color fluorescent layer transmits the visible light reflected from the visible light reflecting layer.

A display device in accordance with still another aspect of the present invention includes a light source, a first substrate, a second substrate, a visible light reflecting layer, and a color fluorescent layer. The first substrate is provided on the light source. The second substrate is provided on the first substrate. The visible light reflecting layer is provided between the first and second substrates for transmitting invisible light and reflecting visible light. The color fluorescent layer is provided between the visible light reflecting layer and the second substrate for generating visible light in response to absorption of invisible light that has passed through the visible light reflecting layer. The color fluorescent layer transmits the visible light reflected from the visible light reflecting layer.

The invisible light and the bluish light that are irradiated onto the fluorescent layer to excite molecules in the fluorescent layer are excitation lights.

In accordance with the present invention, the visible light reflecting layer is formed under the fluorescent layer so that the image is displayed using the visible light generated from the color fluorescent layer and the visible light reflected from the visible light reflecting layer, thereby decreasing manufacturing cost and improving the efficiency of the light.

### BRIEF DESCRIPTION OF THE DRAWINGS

The above and other advantages of the present invention will become more apparent by describing in detail embodiments thereof with reference to the accompanying drawings, in which:

FIG. 1 is a cross-sectional view showing a photoluminescent liquid crystal display (PLLCD) device in accordance with one embodiment of the present invention;

FIG. 2 is a cross-sectional view showing a visible light reflecting layer shown in FIG. 1;

FIG. 3 is an enlarged plan view showing cholesteric liquid crystal molecules shown in FIG. 1;

FIG. 4 is a cross-sectional view showing a method of manufacturing a visible light reflecting layer shown in FIG. 1;

FIGS. 5A and 5B are cross-sectional views showing ultraviolet photo-polymerization mechanism by irradiating light in accordance with one embodiment of the present invention;

FIG. 6 is a cross-sectional view showing optical characteristics of the PLLCD device shown in FIG. 1;

FIG. 7 is a cross-sectional view showing a PLLCD device in accordance with another embodiment of the present invention;

FIG. 8 is a cross-sectional view showing a PLLCD device in accordance with another embodiment of the present invention;

FIG. 9 is a cross-sectional view showing optical characteristics of the PLLCD device shown in FIG. 8;

FIGS. 10A to 10J are cross-sectional views showing a method of manufacturing an opposing substrate shown in FIG. 8;

FIG. 11 is a cross-sectional view showing a PLLCD device in accordance with another embodiment of the present invention; and

FIG. 12 is a cross-sectional view showing a PLLCD device in accordance with another embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to”, or “coupled to” another element or layer, it can be directly on, connected or coupled to the other element or layer or intervening elements or layers may be present. In contrast, when an element is referred to as being “directly on”, “directly connected to”, or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-sectional illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

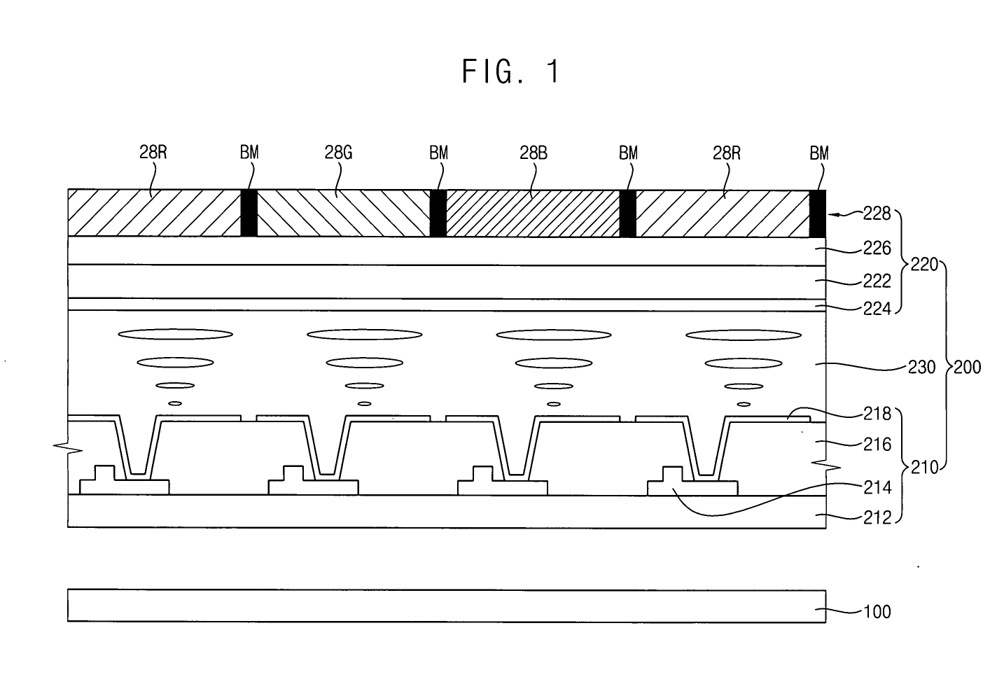

FIG. 1 is a cross-sectional view showing a photoluminescent liquid crystal display (PLLCD) device in accordance with one embodiment of the present invention.

Referring to FIG. 1, the PLLCD device includes a light source 100 and a fluorescent panel 200. The fluorescent panel 200 displays images using light generated by the light source 100.

The light source 100 supplies the fluorescent panel 200 with ultraviolet light. A wavelength of the ultraviolet light is about 200 nm to about 400 nm.

The fluorescent panel 200 includes an array substrate 210, an opposing substrate 220, and a liquid crystal layer 230. The liquid crystal layer 230 is interposed between the array substrate 210 and the opposing substrate 220. The fluorescent panel 200 displays images using the ultraviolet light generated by the light source 100.

The array substrate 210 includes a first transparent substrate 212, a switching element 214, an insulating layer 216, and a pixel electrode 218. The switching element 214 is formed in a pixel region on the first transparent substrate 212. A plurality of switching elements 214 may be formed in a plurality of pixel regions, respectively. The insulating layer 216 includes a contact hole through which an electrode of the switching element 214 is partially exposed. The pixel electrode 218 is electrically connected to the electrode of the switching element 214 through the contact hole.

The switching element 214 may comprise a thin film transistor (TFT). For example, the TFT may be an inverted-staggered type TFT having a gate electrode, with source and drain electrodes positioned over the gate electrode. Alternatively, the TFT may be a staggered type TFT having source and drain electrodes, with a gate electrode positioned over the source and drain electrodes.

In FIG. 1, the insulating layer 216 is thicker than the switching element 214. Alternatively, the insulating layer 216 may be thinner than the switching element 214.

The opposing substrate 220 includes a second transparent substrate 222, a common electrode layer 224, a visible light reflecting layer 226, and a color fluorescent layer 228. The common electrode layer 224 is formed on one surface of the second transparent substrate 222. The visible light reflecting layer 226 is formed on an opposite surface of the second transparent substrate 222. The color fluorescent layer 228 is formed in pixel regions. The second transparent substrate 222 may comprise a glass substrate, a sapphire substrate, a plastic substrate, etc.

A common voltage that is provided from outside of the fluorescent panel 200 is applied to the common electrode layer 224. The common electrode layer 224 is transparent.

The visible light reflecting layer 226 transmits the ultraviolet light from the light source 100 that has passed through the liquid crystal layer 230. Visible light generated by the color fluorescent layer 228 is reflected from the visible light reflecting layer 226.

The color fluorescent layer 228 includes a red fluorescent layer 28R, a green fluorescent layer 28G, and a blue fluorescent layer 28B. Each of the red, green and blue fluorescent layers 28R, 28G and 28B is formed in a pixel region. The color fluorescent layer 228 is formed on the visible light reflecting layer 226. The pixel regions are defined by a black matrix BM.

The color fluorescent layer 228 is excited by the ultraviolet light that has passed through the visible light reflecting layer 226. The excitation of the color fluorescent layer 228 causes the color fluorescent layer 228 to generate visible light. Visible light that is directed towards the visible light reflecting layer 226 is reflected from the visible light reflecting layer 226 and passes through the color fluorescent layer 228. The color fluorescent layer 228 comprises an inorganic fluorescent material or an organic fluorescent material.

In FIG. 1, the color fluorescent layer 228 comprises an inorganic fluorescent material. For example, the red, green, and blue fluorescent layers 28R, 28G, and 28B comprise Y₂O₂S:Eu, (Sr, Ca, Ba, Eu)₁₀(PO₄)₆.Cl₂, and 3(Ba, Mg, Eu, Mn)O.8Al₂O₃, respectively. Alternatively, the color fluorescent layer 228 may comprise an organic fluorescent material, and the red and green fluorescent layers 28R and 28G may comprise rhodamine B, and brilliantsulfoflavine FF, respectively.

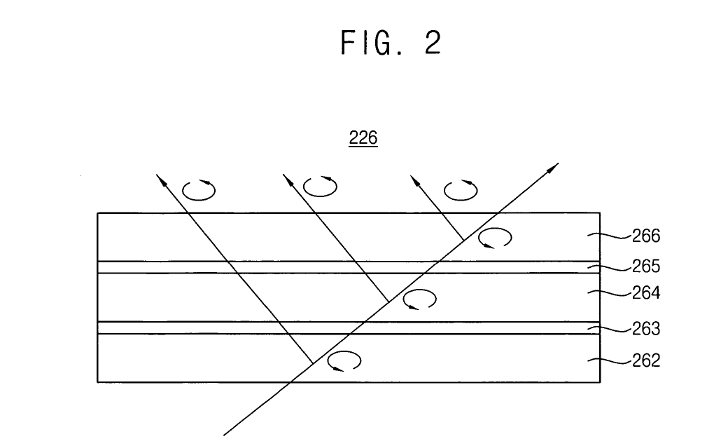

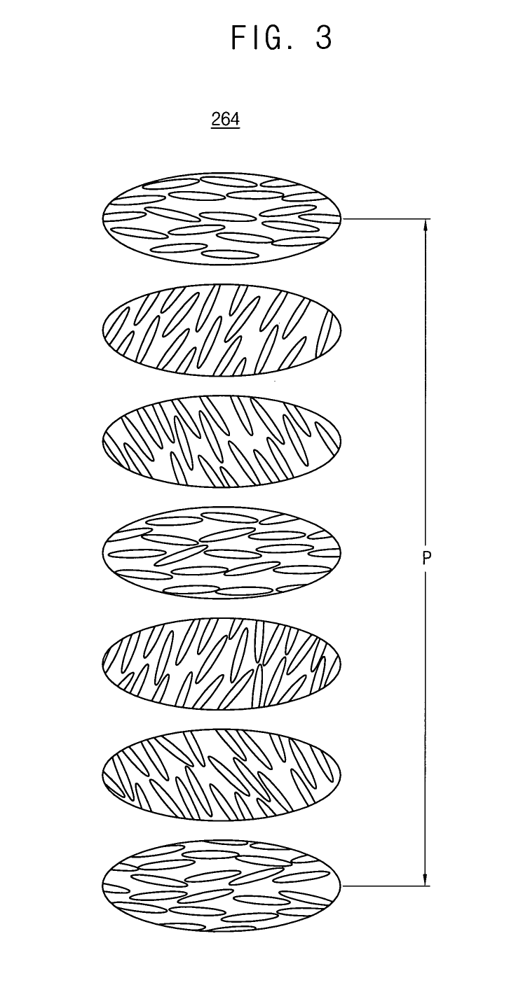

FIG. 2 is a cross-sectional view showing a visible light reflecting layer shown in FIG. 1. FIG. 3 is an enlarged plan view showing cholesteric liquid crystal molecules shown in FIG. 1.

Referring to FIGS. 2 and 3, the visible light reflecting layer 226 includes a first liquid crystal film 262, a second liquid crystal film 264, and a third liquid crystal film 266. A red portion of the visible light is reflected from the first liquid crystal film 262. A green portion of the visible light is reflected from the second liquid crystal film 264. A blue portion of the visible light is reflected from the third liquid crystal film 266. In FIG. 2, the second liquid crystal film 264 is on the first liquid crystal film 262, and the third liquid crystal film 266 is on the second liquid crystal film 264. The first liquid crystal film 262 is attached to the second liquid crystal film 264 through a first adhesive layer 263 interposed between the first and second liquid crystal films 262 and 264. The second liquid crystal film 264 is attached to the third liquid crystal film 266 through a second adhesive layer 265 interposed between the second and third liquid crystal films 264 and 266.

Each of the first, second, and third liquid crystal films 262, 264, and 266 comprises a cholesteric liquid crystal. Liquid crystal molecules of the cholesteric liquid crystal have rod shape oriented to form a spire. The liquid crystal molecules of the cholesteric liquid crystal are repeatedly twisted to form a twisted structure having a pitch P.

Bragg reflection results from the twisted structure of the cholesteric liquid crystal. When a chiral axis of the cholesteric liquid crystal is substantially perpendicular to a base surface, light having a wavelength λ corresponding to the pitch P is reflected from the cholesteric liquid crystal, and light having a wavelength λ different from the pitch P passes through the cholesteric liquid crystal. The wavelength λ of the light reflected is proportion to the pitch P multiplied by a refractive index Δn of the cholesteric liquid crystal (λ=P*Δn).

When the cholesteric liquid crystal has a predetermined thickness, a reflectivity of the cholesteric liquid crystal is about 50% The predetermined thickness means a thickness of which the reflective ratio is over 50%. Thus, a ratio of an amount of the reflected light to an amount of the light passing through the cholesteric liquid crystal is about 1:1. For example, when the thickness of the cholesteric liquid crystal is about ten times of the pitch P, the reflectivity of the cholesteric liquid crystal is about 50%.

The reflected light that is reflected from the cholesteric liquid crystal may have a right handed circular polarization or a left handed circular polarization. When the liquid crystal molecules of the cholesteric liquid crystal are twisted in a right handed direction, the reflected light has a right handed circular polarization. When the liquid crystal molecules of the cholesteric liquid crystal are twisted in a left handed direction, the reflected light has a left handed circular polarization. The light passing through the cholesteric liquid crystal has the opposite polarization direction of the reflected light.

In FIGS. 2 and 3, the first, second, and third liquid crystal films 262, 264, and 266 have different pitches P from one another. Light having a wavelength λ that equals the pitch P of one of the first, second, and third liquid crystal films 262, 264 and 266 multiplied by the refractive index Δn of the first, second, and third liquid crystal films 262, 264, and 266, respectively, is reflected from the first, second and third liquid crystal films 262, 264 and 266. The first liquid crystal film 262 has greater pitch P than the second liquid crystal film 264. The second liquid crystal film 264 has greater pitch P than the third liquid crystal film 266.

Each of the first, second, and third liquid crystal films 262, 264, and 266 includes a solvent, and a mixture of a cholesteric liquid crystal and a vertically aligned liquid crystal. A ratio of the cholesteric liquid crystal and the vertically aligned liquid crystal is controlled to change the wavelength λ of the reflected light that is reflected from each of the first, second, and third liquid crystal films 262, 264, and 266.

For example, the ratios of the cholesteric liquid crystal and the vertically aligned liquid crystal in the first, second, and third liquid crystal films 262, 264, and 266 are about 8:2, about 7:3, and about 6:4, respectively.

The light that is polarized in the same direction as the orientation of the cholesteric liquid crystal of each of the first, second, and third liquid crystal films 262, 264, and 266 is reflected from each of the first, second, and third liquid crystal films 262, 264, and 266 In addition, the light that is polarized in a different direction from the orientation of the cholesteric liquid crystal of each of the first, second, and third liquid crystal films 262, 264, and 266 passes through each of the first, second, and third liquid crystal films 262, 264, and 266. Therefore, the reflected light has substantially the same twisted direction as the cholesteric liquid crystal, and the light passing through the cholesteric liquid crystal has an opposite twisted direction to the cholesteric liquid crystal.

In FIG. 2, each of the first and second adhesive layers 263 and 265 comprises an ultraviolet curable resin. An ultraviolet light is irradiated onto the first and second adhesive layers 263 and 265 so that the first, second, and third liquid crystal films 262, 264 and 266 are combined with each other.

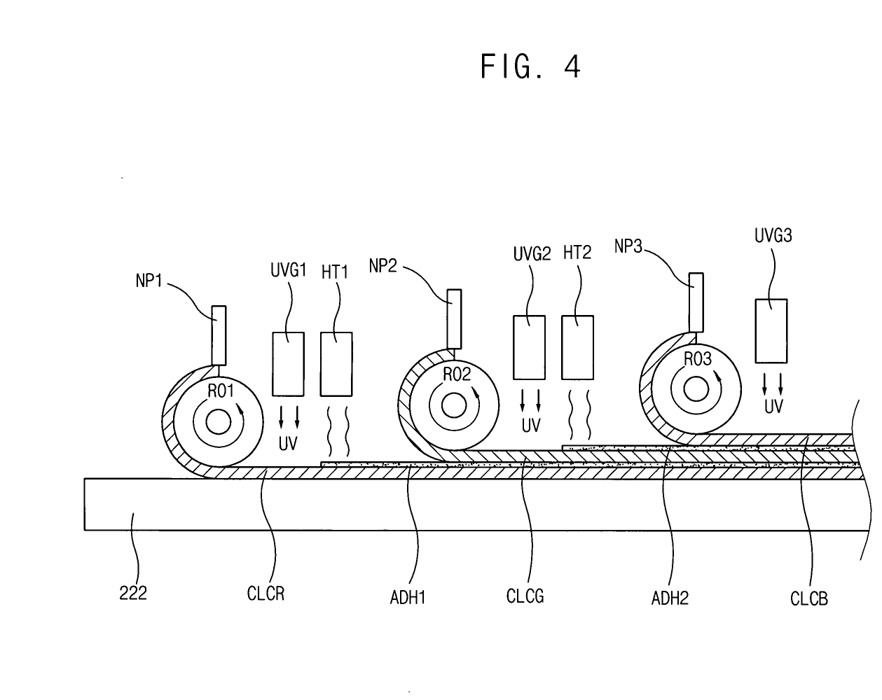

As a result of the structure of the fluorescent panel 200 shown in FIGS. 1 to 3, the visible light reflected by liquid crystal films is reused 228 to improve a luminance of the fluorescent panel 200 FIG. 4 is a cross-sectional view showing a method of manufacturing a visible light reflecting layer shown in FIG. 1.

Referring to FIGS. 1 and 4, a first solution layer CLCR (“cholesteric liquid crystal—red”) comprising a mixture of the cholesteric liquid crystal and the vertically aligned liquid crystal in a first mixing ratio is coated on the second transparent substrate 222 using a first nipper NP1 and a first roller RO1. A nipper and roller are tools for coating An ultraviolet light is irradiated onto the first solution layer CLCR to solidify the first solution layer CLCR. A first adhesive layer ADH1 is coated on the solidified first solution layer CLCR.

The first mixing ratio of cholesteric liquid crystal in the first solution layer CLCR is controlled to produce a first solution layer CLCR that reflects red light. In this embodiment, the first ratio of the first solution layer CLCR is about 8:2 The first solution layer CLCR further comprises about 5 wt % of an ultraviolet photo-polymerization initiator and about 50 wt % of a solvent. In FIG. 4, the ultraviolet photo-polymerization initiator is Igacure 184 (available from Ciba-Geigy Co, Ltd, of Switzerland), and the solvent is toluene. The cholesteric liquid crystal, the vertically aligned liquid crystal, the Igacure 184, and the toluene are mixed at a temperature of about 80° C. to about 90° C. for about thirty minutes to form a first solution for the first solution layer CLCR.

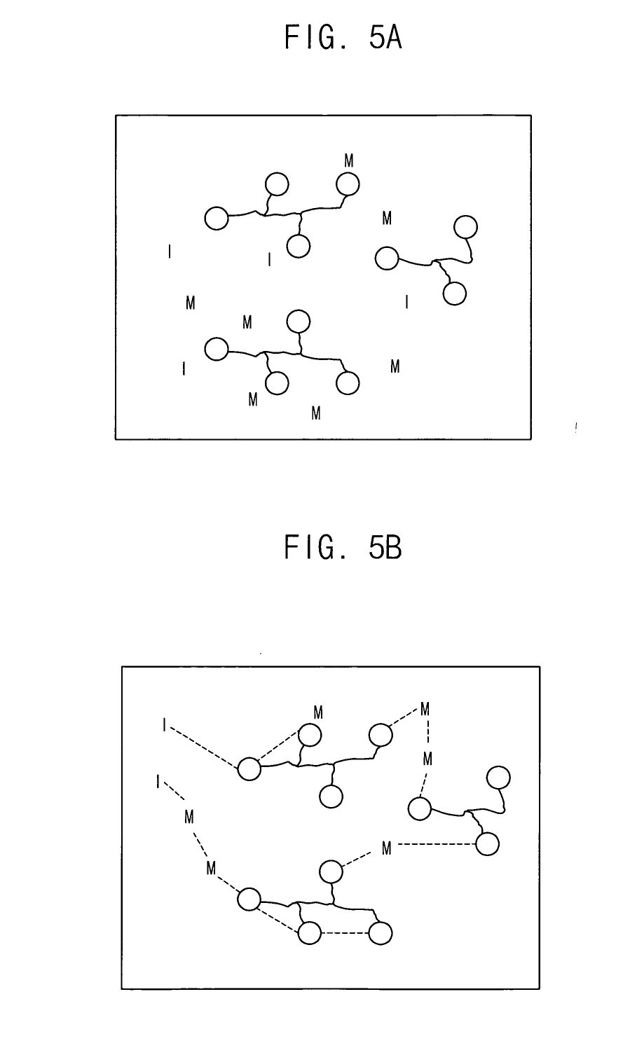

FIGS. 5A and 5B are cross-sectional views showing an ultraviolet photo-polymerization mechanism by irradiating light in accordance with one embodiment of the present invention. Reference numerals “I”, “M”, and “O-O” represent the photo-polymerization initiator, a photo-polymerization monomer, and a photo-polymerization oligomer, respectively.

Referring to FIG. 5A, an ultraviolet crosslink agent includes a crosslink polymer solution comprising the photo-polymerization initiator, the photo-polymerization monomer, and the photo-polymerization oligomer. In FIG. 5B, when ultraviolet light is irradiated onto the ultraviolet crosslink agent, the adhesive layer is attached to one of the first, second, and third liquid crystal films 262, 264, and 266 shown in FIG. 2. The irradiation enables control of the refractive index and light transmittance of the visible light reflecting layer 226 shown in FIG. 2. FIG. 5a is a state before UV light entering into, FIG. 5b is a state after UV light entering into. In FIGS. 5A and 5B, the ultraviolet curable resin is acryl based, and includes the photo-polymerization monomer, the photo-polymerization oligomer, and the photo-polymerization initiator. A shrinkage ratio of the ultraviolet curable resin is no more than 20% d ring solidification. Examples of the photo-polymerization monomer or the photo-polymerization oligomer include an acrylate resin, an epoxy based acrylate resin, a polyester based acrylate resin, a urethane based acrylate resin, etc. Examples of the photo-polymerization initiator include an acetophenone based resin, a benzophenone based resin, a thioxanthone based resin, Igacure series, etc.

Referring again to FIG. 4, a second solution layer CLCG (“cholesteric liquid crystal—green”) that is a mixture of the cholesteric liquid crystal and the vertically aligned liquid crystal in a second mixing ratio is coated on the first adhesive layer ADH1 using a second nipper NP2 and a second roller RO2. An ultraviolet light is irradiated onto the second solution layer CLCG to solidify the second solution layer CLCG. The second adhesive layer ADH2 is coated on the solidified second solution layer CLCG.

The second mixing ratio of cholesteric liquid crystal to vertically aligned liquid crystal in the second solution layer CLCG is controlled to produce a second solution layer CLCG that reflects green light. In this embodiment, the second ratio of the second solution layer CLCG is about 7:3. The second solution layer CLCG further comprises about 5 wt % of an ultraviolet photo-polymerization initiator and about 50 wt % of a solvent. In FIG. 4, the ultraviolet photo-polymerization initiator is Igacure 184, and the solvent is toluene. The cholesteric liquid crystal, the vertically aligned liquid crystal, the Igacure 184, and the toluene are mixed at a temperature of about 80° C. to about 90° C. for about thirty minutes to form a second solution for the second solution layer CLCG.

A third solution layer CLCB (“cholesteric liquid crystal—blue”) that is a mixture of the cholesteric liquid crystal and the vertically aligned liquid crystal in a third mixing ratio is coated on the second adhesive layer ADH2 using a third nipper NP3 and a third roller RO3. An ultraviolet light is irradiated onto the third solution layer CLCB to solidify the third solution layer CLCB.

The third mixing ratio of cholesteric liquid crystal to vertically aligned liquid crystal in the third solution layer CLCB is controlled to produce a third solution layer CLCB that reflects blue light. In this embodiment, the third ratio of the third solution layer CLCB is about 6:4. The third solution layer CLCB further comprises about 5 wt % of an ultraviolet photo-polymerization initiator and about 50 wt % of a solvent. In FIG. 4, the ultraviolet photo-polymerization initiator is Igacure 184, and the solvent is toluene. The cholesteric liquid crystal, the vertically aligned liquid crystal, the Igacure 184, and the toluene are mixed at a temperature of a bout 80° C. to a bout 90° C. for about thirty minutes to form a third solution for the third solution layer CLCB.

In FIGS. 1 to 5B, the mixing ratios of the cholesteric liquid crystal and the vertically aligned liquid crystal for the first, second, and third solution layers CLCR, CLCG, and CLCB are about 8:2, about 7:3, and about 6:4, respectively. Alternatively, the mixing ratios of the cholesteric liquid crystal and the vertically aligned liquid crystal may be about 7.5:2.5, about 6.5:3.5, and about 5.5:4.5, respectively. The mixing ratios may vary in other embodiments.

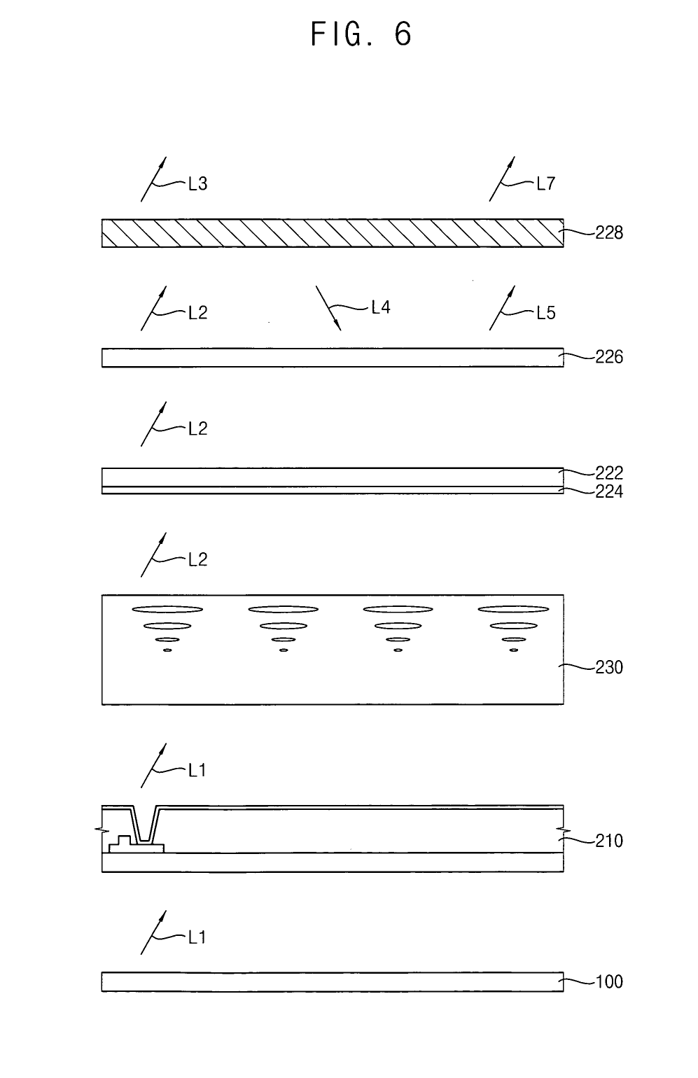

FIG. 6 is a cross-sectional view showing optical characteristics of the PLLCD device shown in FIG. 1.

Referring to FIGS. 1 and 6, a first ultraviolet light L1 that is generated by the light source 100 passes through the array substrate 210 to be incident into the liquid crystal layer 230.

A second ultraviolet light L2 is produced from the first ultraviolet light L1 after the first ultraviolet light L1 has passed through the liquid crystal layer 230. The second ultraviolet light L2 passes through the common electrode layer 224 and the second transparent substrate 222 to be incident into the visible light reflecting layer 226. The amount of the second ultraviolet light L2 is controlled by the adjustment of a liquid crystal arrangement in the liquid crystal layer 230.

The second ultraviolet light L2 passes through the visible light reflecting layer 226 to be incident into the color fluorescent layer 228.

When the second ultraviolet light L2 is incident into the color fluorescent layer 228, molecules in the color fluorescent layer 228 are excited to emit a first visible light L3 toward a front of the fluorescent panel 200.

A second visible light L4 that is a portion of the light generated from the excitation of the color fluorescent layer 228 is irradiated onto the visible light reflecting layer 226 toward a rear of the fluorescent panel 200. The second visible light L4 that is incident into the visible light reflecting layer 226 is reflected from the visible light reflecting layer 226 to produce a third visible light L5. The third visible light L5 that is reflected from the visible light reflecting layer 226 passes through the color fluorescent layer 228 toward the front of the fluorescent panel 200.

According to the fluorescent panel 200 shown in FIGS. 1 to 6, the fluorescent panel 200 displays images using the first visible light L3 that is emitted directly from the color fluorescent layer 228 and the third visible light L5 that indirectly exits from the color fluorescent layer 228 after being reflected by the visible light reflecting layer 226 and passing through the color fluorescent layer 228. As a result, the luminance of the fluorescent panel 200 is increased, and the power consumption of the display device is decreased.

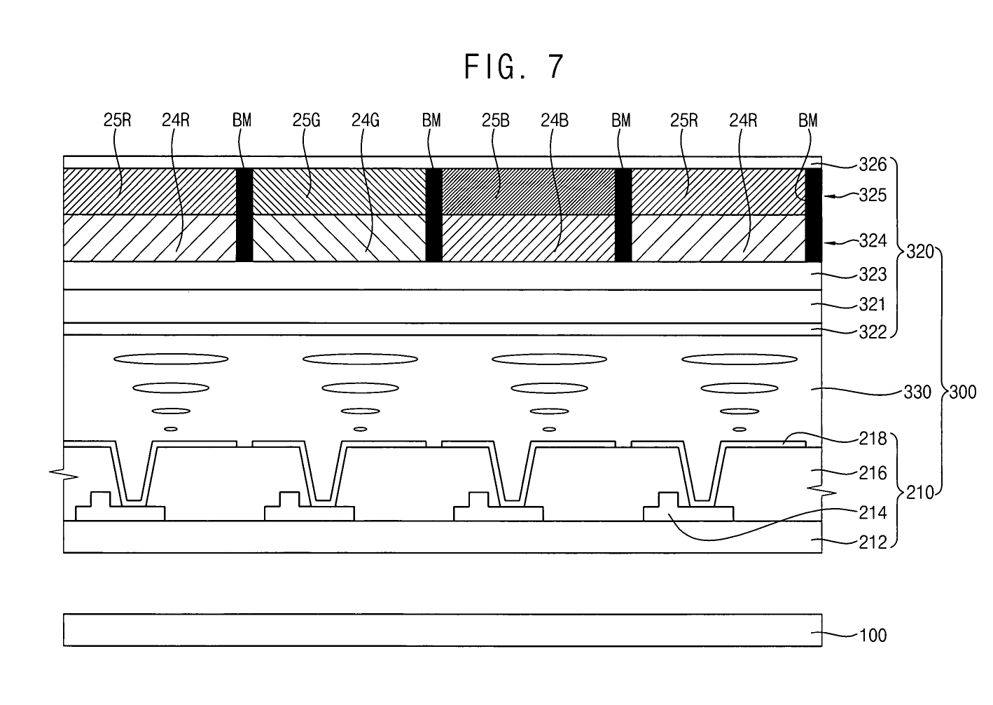

FIG. 7 is a cross-sectional view showing a PLLCD device in accordance with another embodiment of the present invention.

Referring to FIG. 7, the PLLCD includes a light source 100 and a fluorescent panel 300. The fluorescent panel 300 displays images using light generated by the light source 100.

The light source 100 supplies the fluorescent panel 300 with ultraviolet light. A wavelength of the ultraviolet light is about 200 nm to about 400 nm.

The fluorescent panel 300 includes an array substrate 210, an opposing substrate 320, and a liquid crystal layer 330. The liquid crystal layer 330 is interposed between the array substrate 210 and the opposing substrate 320. The fluorescent panel 300 displays images using the ultraviolet light generated by the light source 100. The array substrate 210 of FIG. 7 is substantially the same as in FIG. 1. Thus, the same reference numerals will be used to refer to the same or like parts as those described in FIG. 1 and any further explanation concerning the above elements will be omitted.

The opposing substrate 320 includes a second transparent substrate 321, a common electrode layer 322, a visible light reflecting layer 323, a color fluorescent layer 324, a color filter layer 325, and an anti-glare layer 326. The common electrode layer 322 is formed on one surface of the second transparent substrate 321. The visible light reflecting layer 323 is formed on an opposite surface of the second transparent substrate 321. The color fluorescent layer 324 is formed in pixel regions. The color filter layer 325 is provided on the color fluorescent layer 324. The anti-glare layer 326 is provided on the color filter layer 325.

A common voltage that is provided from outside of the fluorescent panel 300 is applied to the common electrode layer 322. The common electrode layer 322 is transparent.

The visible light reflecting layer 323 transmits ultraviolet light that has passed through the liquid crystal layer 330. Visible light generated by the color fluorescent layer 324 is reflected from the visible light reflecting layer 323. Visible light having a wavelength λ corresponding to a pitch P of a cholesteric liquid crystal in the visible light reflecting layer 323 is reflected from the cholesteric liquid crystal, and visible light having a wavelength λ different from the pitch P passes through the cholesteric liquid crystal. As a result, visible light is selectively reflected from the visible light reflecting layer 323. The wavelength λ of the light is proportion to the pitch P multiplied by a refractive index Δn of the cholesteric liquid crystal (λ=P*Δn).

The color fluorescent layer 324 includes a red fluorescent layer 24R, a green fluorescent layer 24G, and a blue fluorescent layer 24B. Each of the red, green, and blue fluorescent layers 24R, 24G, and 24B is formed in a pixel region. The color fluorescent layer 324 is formed on the visible light reflecting layer 323. The pixel regions are defined by a black matrix BM The color fluorescent layer 324 is excited by the ultraviolet light that has passed through the visible light reflecting layer 324. The excitation of the color fluorescent layer 324 causes the color fluorescent layer 324 to generate visible light. Visible light that is directed towards the visible light reflecting layer 323 is reflected from the visible light reflecting layer 323 and passes through the color fluorescent layer 324.

The color filter layer 325 includes a red color filter layer, a green color filter layer, and a blue color filter layer. Each of the red, green, and blue color filter layers is provided in respective pixel regions. The color filter layer 325 also blocks ultraviolet light that has passed through the color fluorescent layer 324.

The anti-glare layer 326 has a haze surface. The anti-glare layer 326 may comprise a plurality of resin layers having haze values H of about 12%, about 25%, about 44%, etc. The haze value H is determined as follows. The haze value H is determined by following Equation 1, wherein H1 and H2 represent a luminance of a light that passes through the anti-glare layer 326 in an incident direction and a luminance of a light diffused in the anti-glare layer 326, respectively.

$$H = \frac{{H}^{2}}{{H}^{1} + {H}^{2}} \times 100 [ \% ] \qquad Equation 1$$

In FIG. 7, the visible light reflecting layer 323 is provided on the second transparent substrate 321. The color fluorescent layer 324 is provided on the visible light reflecting layer 323. The color filter layer 325 is provided on the color fluorescent layer 324. The anti-glare layer 326 is provided on the color filter layer 325. In other embodiments, the anti-glare layer 326 may be omitted.

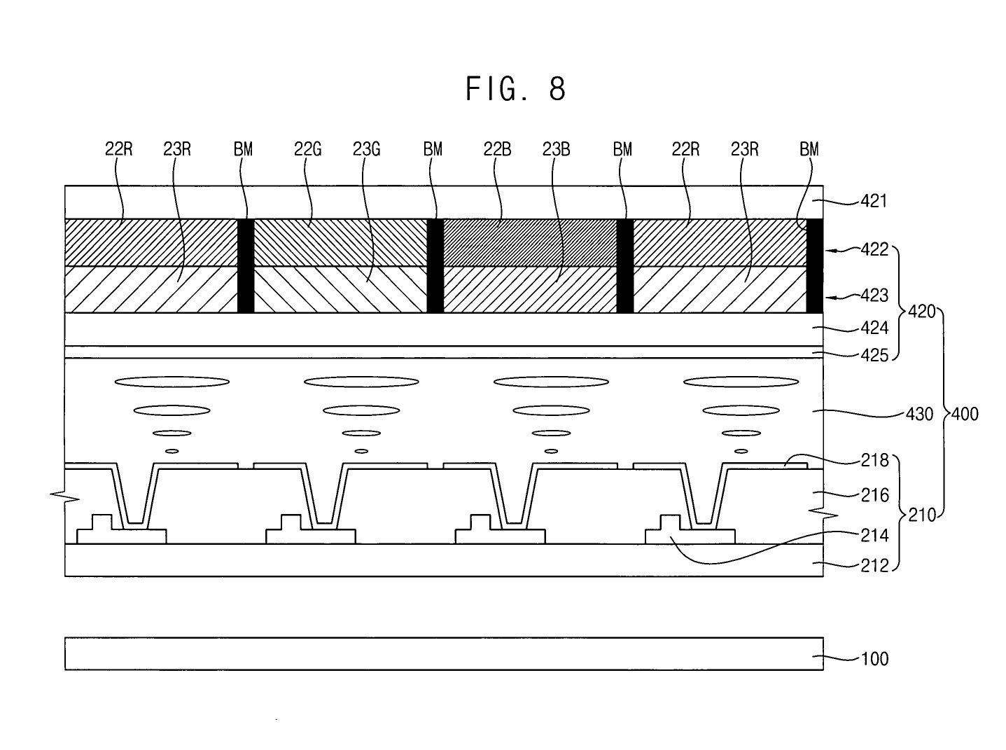

FIG. 8 is a cross-sectional view showing a PLLCD device in accordance with another embodiment of the present invention. The PLLCD device includes a color fluorescent layer, a fluorescent layer, and a liquid crystal layer.

Referring to FIG. 8, the PLLCD includes a light source 100 and a fluorescent panel 400. The fluorescent panel 400 displays images using light generated by the light source 100.

The light source 100 supplies the fluorescent panel 300 with ultraviolet light. A wavelength of the ultraviolet light is about 200 nm to about 400 nm.

The fluorescent panel 400 includes an array substrate 210, an opposing substrate 420, and a liquid crystal layer 430. The liquid crystal layer 430 is interposed between the array substrate 210 and the opposing substrate 420. The fluorescent panel 400 displays images using ultraviolet light generated by the light source 100. The array substrate 210 of FIG. 8 is substantially the same as in FIG. 1. Thus, the same reference numerals will be used to refer to the same or like parts as those described in FIG. 1 and any further explanation concerning the above elements will be omitted.

The opposing substrate 420 includes a second transparent substrate 421, a color filter layer 422, a color fluorescent layer 423, a visible light reflecting layer 424, and a common electrode layer 425. The color filter layer 422 is provided on the second transparent substrate 421. The color fluorescent layer 423 is provided on the color filter layer 422. The visible light reflecting layer 424 is provided on the color fluorescent layer 423. The common electrode layer 425 is provided on the visible light reflecting layer 424.

A common voltage that is provided from outside of the fluorescent panel 400 is applied to the common electrode layer 425. The common electrode layer 425 is transparent.

The visible light reflecting layer 424 transmits ultraviolet light that has passed through the liquid crystal layer 430. Visible light generated by the color fluorescent layer 423 is reflected from the visible light reflecting layer 424.

The color fluorescent layer 423 includes a red fluorescent layer 23R, a green fluorescent layer 23G, and a blue fluorescent layer 23B. Each of the red, green, and blue fluorescent layers 23R, 23G, and 23B are formed in respective pixel regions. The color fluorescent layer 423 is formed on the visible light reflecting layer 424. The pixel regions are defined by a black matrix BM. The color fluorescent layer 423 is excited by the ultraviolet light that has passed through the visible light reflecting layer 424. The excitation of the color fluorescent layer 423 causes the color fluorescent layer 423 to generate visible light. Visible light that is directed towards the visible light reflecting layer 424 is reflected from the visible light reflecting layer 424 and passes through the color fluorescent layer 423.

In particular, the red fluorescent layer 23R is excited by the ultraviolet light that has passed through the visible light reflecting layer 424 to generate red light. A portion of the red light that is reflected from the visible light reflecting layer 424 passes through the red fluorescent layer 23R to be incident into the color filter layer 422.

The green fluorescent layer 23G is excited by the ultraviolet light that has passed through the visible light reflecting layer 424 to generate green light. A portion of the green light that is reflected from the visible light reflecting layer 424 passes through the green fluorescent layer 23G to be incident into the color filter layer 422.

The blue fluorescent layer 23B is excited by the ultraviolet light that has passed through the visible light reflecting layer 424 to generate blue light. A portion of the blue light that is reflected from the visible light reflecting layer 424 passes through the blue fluorescent layer 23B to be incident into the color filter layer 422.

The color filter layer 422 includes a red color filter layer 22R, a green color filter layer 22G, and a blue color filter layer 22B. Each of the red, green, and blue color filter layers 22R, 22G, and 22B are provided in respective pixel regions. The color filter layer 422 also blocks the ultraviolet light that has passed through the color fluorescent layer 423.

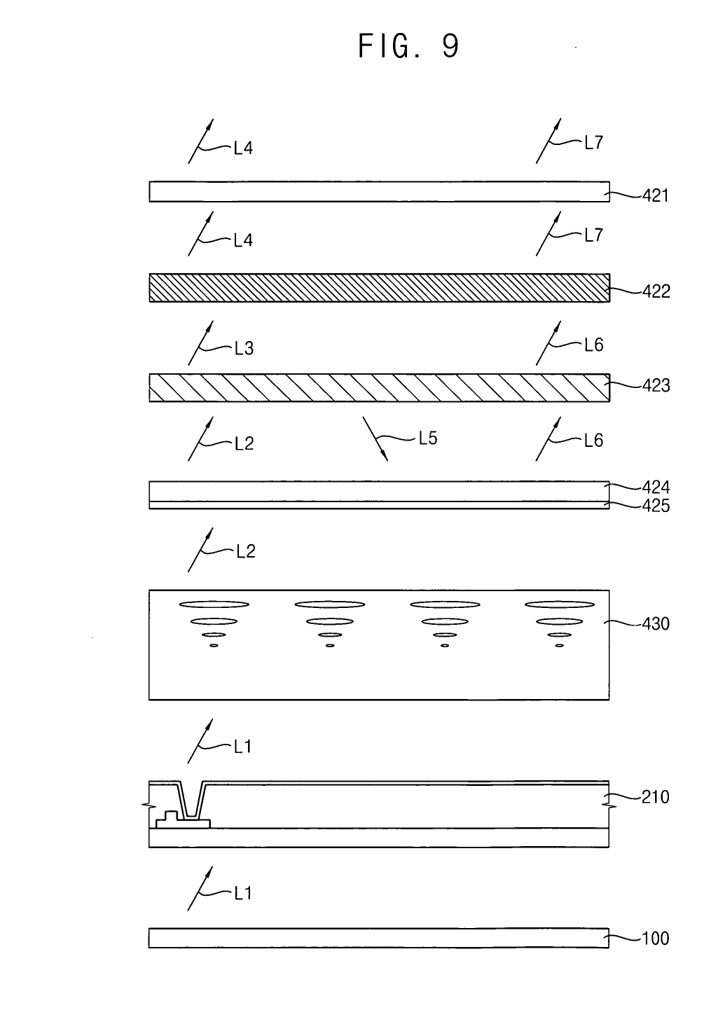

FIG. 9 is a cross-sectional view showing optical characteristics of the PLLCD device shown in FIG. 8.

Referring to FIGS. 8 and 9, a first ultraviolet light L1 that is generated by the light source 100 passes through the array substrate 210 to be incident into the liquid crystal layer 430.

A second ultraviolet light L2 is produced from the first ultraviolet light L1 after the first ultraviolet light L1 has passed through the liquid crystal layer 430. The second ultraviolet light L2 passes through the common electrode layer 425 to be incident into the visible light reflecting layer 424. The amount of the second ultraviolet light L2 is controlled by the adjustment of a liquid crystal arrangement in the liquid crystal layer 230 The second ultraviolet light L2 passes through the visible light reflecting layer 424 to be incident into the color fluorescent layer 423.

When the second ultraviolet light L2 is incident into the color fluorescent layer 423, molecules in the color fluorescent layer 423 are excited to emit a first visible light L3 toward a front of the fluorescent panel 400. The first visible light L3 passes into the color filter layer 422. The color filter layer 422 blocks an invisible light component of the second visible light L3 to form a second visible light L4. The second visible light L4 passes through the second transparent substrate 421.

A third visible light L5 that is a portion of the light generated by the color fluorescent layer 423 is irradiated onto the visible light reflecting layer 424. The third visible light L5 that is incident into the visible light reflecting layer 424 is reflected by the visible light reflecting layer 424 to produce a fourth visible light L6. The fourth visible light L6 is reflected from the visible light reflecting layer 424 and passes through the color fluorescent layer 424 toward the front of the fluorescent panel 400. The fourth visible light L6 passes into the color filter layer 422. The color filter layer 422 blocks an invisible light component of the fourth visible light L6 to form a fifth visible light L7. The fifth visible light L7 passes through the second transparent substrate 421.

According to the fluorescent panel 400 shown in FIGS. 8 and 9, the fluorescent panel 400 displays images using the second visible light L4 that is emitted directly from the color fluorescent layer 423 through the color filter layer 422 and the fifth visible light L7 that indirectly exits from the color fluorescent layer 423 after being reflected by the visible light reflecting layer 424 and passing through the color fluorescent layer 423 and the color filter layer 422. As a result, the luminance of the fluorescent panel 400 is increased, and the power consumption of the display device is decreased.

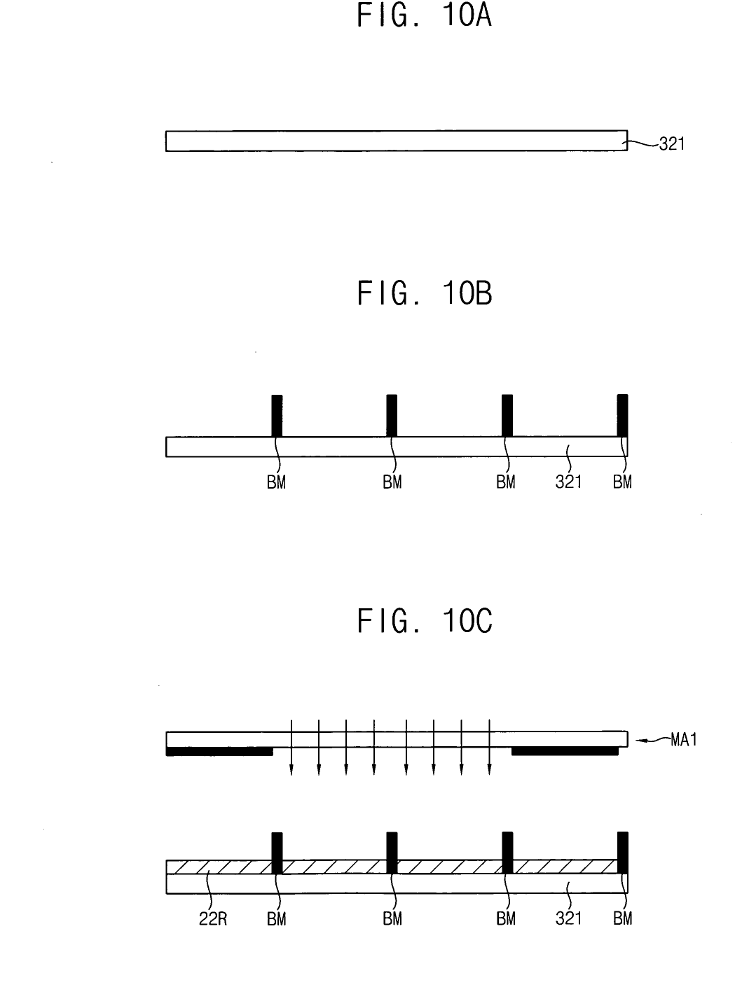

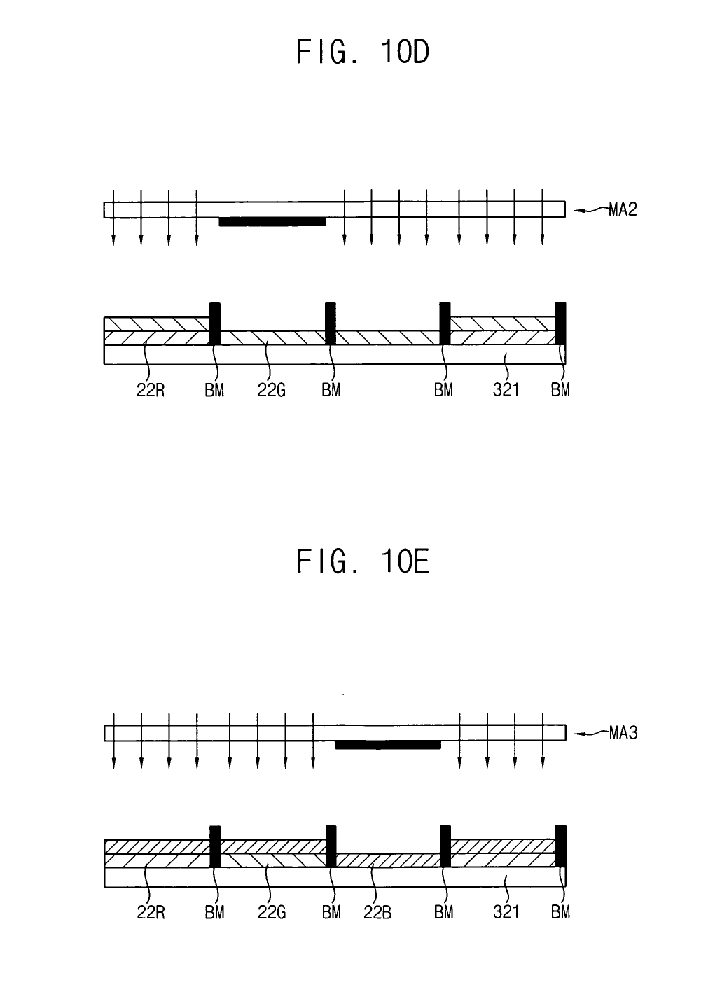

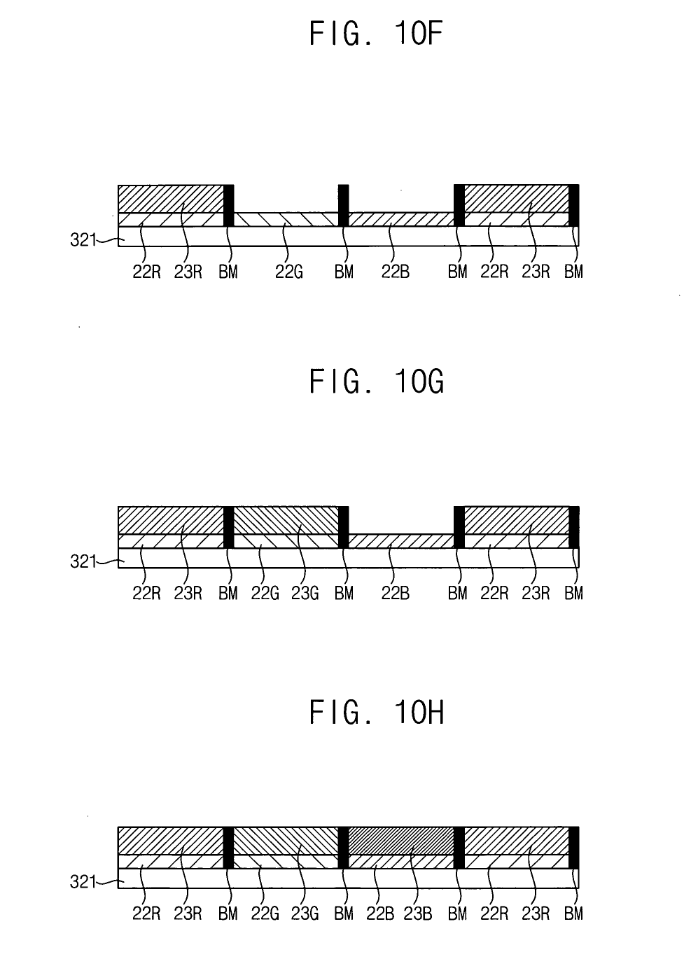

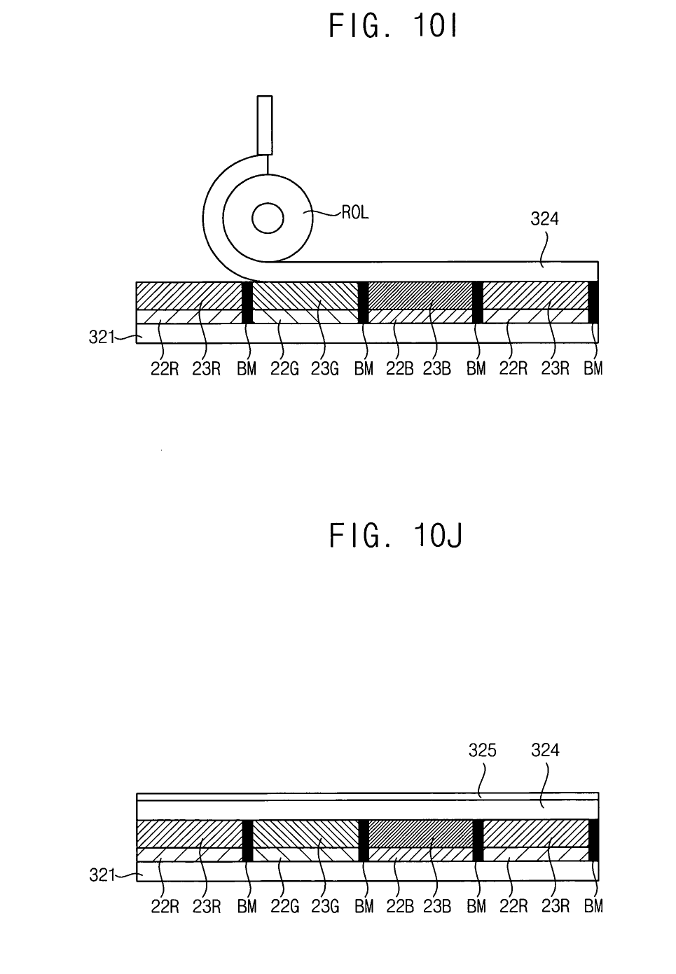

FIGS. 10A to 10J are cross-sectional views showing a method of manufacturing an opposing substrate shown in FIG. 8.

Referring to FIGS. 10A and 10B, a chromium (Cr) layer is formed on the second transparent substrate 321. A positive type photoresist layer is coated on the chromium (Cr) layer. The photoresist layer is exposed through a photo mask, and developed to form photoresist patterns. The chromium (Cr) layer is then partially etched using the photoresist patterns as an etching mask to form the black matrix BM. The black matrix BM has a matrix shape, and corresponds to gate and data lines of the array substrate 210.

Referring to FIGS. 10C to 10E, a photoresist layer for a red color filter is coated on the second transparent substrate 321 having the black matrix BM. The photoresist layer for the red color filter is exposed and developed to form the red color filter layer 22R. The red color filter layer 22R has smaller height than the black matrix BM. The green and blue color filter layers 22G and 22B are formed through similar processes as the red color filter layer 22R.

The red, green, and blue color filter layers 22R, 22G, and 22B may be formed in various ways. In FIGS. 10C to 10E, different masks are used for forming the red, green, and blue color filter layers 22R, 22G, and 22B. Alternatively, when the red, green, and blue color filter layers 22R, 22G, and 22B have substantially the same size, one mask may be shifted to form the red, green, and blue color filter layers 22R, 22G, and 22B.

The red, green, and blue color filters 22R, 22G, and 22B shown in FIGS. 10C to 10E have substantially the same thickness. Alternatively, the red, green, and blue color filters 22R, 22G, and 22B may have different thicknesses from each other.

Referring to FIGS. 10F to 10H, the red, green, and blue fluorescent layers 23R, 23G, and 23B are formed on the red, green, and blue color filter layers 22R, 22G, and 22B, respectively. The red, green, and blue fluorescent layers 23R, 23G, and 23B may be formed through an ink jet process. In FIGS. 10F to 10H, the red, green, and blue fluorescent layers 23R, 23G, and 23B have substantially the same thickness and may provide a planar surface with the black matrix BM. Alternatively, the red, green, and blue fluorescent layers 23R, 23G, and 23B may have different thicknesses from each other.

Referring to FIG. 10I, the visible light reflecting layer 324 is formed on the black matrix BM and the red, green, and blue fluorescent layers 23R, 23G, and 23B through the method shown in FIG. 4.

Referring to FIG. 10J, the common electrode layer 325 is formed on the visible light reflecting layer 324.

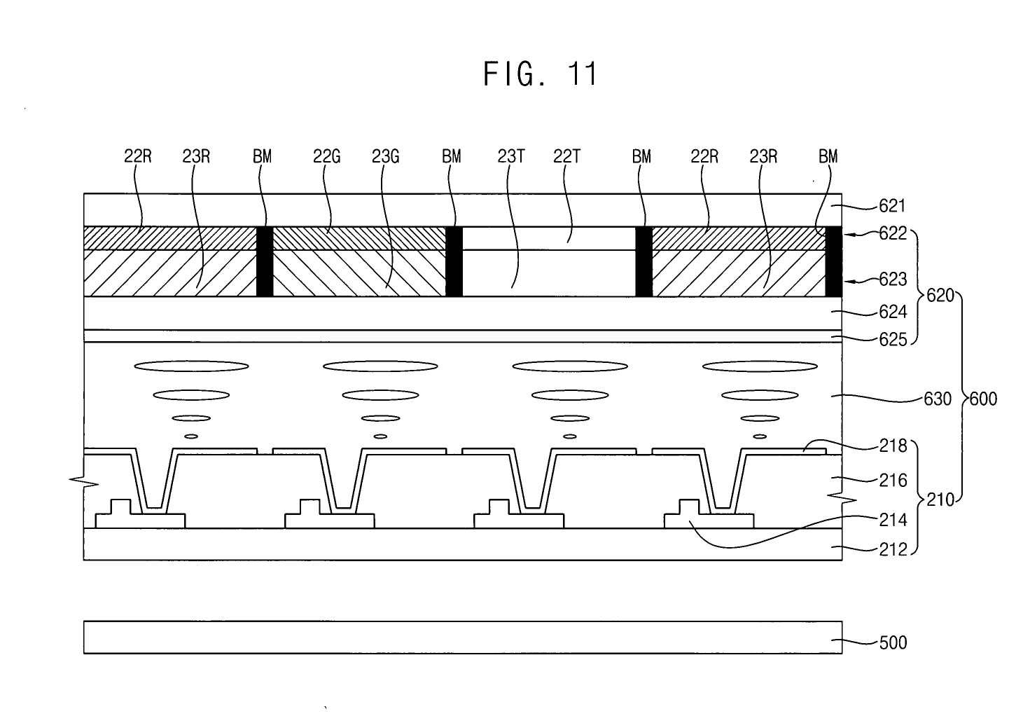

FIG. 11 is a cross-sectional view showing a PLLCD device in accordance with another embodiment of the present invention. The PLLCD device includes a light source generating a bluish light.

Referring to FIG. 11, the PLLCD includes a light source 500 and a fluorescent panel 600. The fluorescent panel 600 displays images using light generated by the light source 500.

The light source 500 supplies the fluorescent panel 600 with a bluish light. A wavelength of the bluish light is about 350 nm to about 450 nm.

The fluorescent panel 600 includes an array substrate 210, an opposing substrate 620 and a liquid crystal layer 630. The liquid crystal layer 630 is interposed between the array substrate 210 and the opposing substrate 620. The fluorescent panel 600 displays images using the bluish light generated by the light source 500. The array substrate 210 of FIG. 11 is substantially the same as in FIG. 1. Thus, the same reference numerals will be used to refer to the same or like parts as those described in FIG. 1 and any further explanation concerning the above elements will be omitted.

The opposing substrate 620 includes a second transparent substrate 621, a color filter layer 622, a color fluorescent layer 623, a visible light reflecting layer 624, and a common electrode layer 625. The color filter layer 622 is provided on the second transparent substrate 621. The color fluorescent layer 623 is provided on the color filter layer 622. The visible light reflecting layer 624 is provided on the color fluorescent layer 623. The common electrode layer 625 is provided on the visible light reflecting layer 624.

A common voltage that is provided from outside of the fluorescent panel 600 is applied to the common electrode layer 625. The common electrode layer 625 is transparent.

The visible light reflecting layer 624 transmits the bluish light that has passed through the liquid crystal layer 630. Visible light generated by the color fluorescent layer 623 is reflected from the visible light reflecting layer 624. The color fluorescent layer 623 includes a red fluorescent layer 23R, a green fluorescent layer 23G, and a first transparent layer 23T. Each of the red and green fluorescent layers 23R and 23G and the first transparent layer 23T is formed in respective pixel regions. The color fluorescent layer 423 is formed on the visible light reflecting layer 624. The pixel regions are defined by a black matrix BM. The color fluorescent layer 623 is excited by the bluish light that has passed through the visible light reflecting layer 624 to generate the visible light. Visible light that is directed back towards the visible light reflecting layer 624 is reflected by the visible light reflecting layer 624. The reflected visible light passes through the color fluorescent layer 623.

In particular, the red fluorescent layer 23R is excited by the bluish light that has passed through the visible light reflecting layer 624 to generate a red light. A portion of the red light that is reflected from the visible light reflecting layer 624 passes through the red fluorescent layer 23R to be incident into the color filter layer 622.

The green fluorescent layer 23G is excited by the bluish light that has passed through the visible light reflecting layer 624 to generate a green light. A portion of the green light that is reflected from the visible light reflecting layer 624 passes through the green fluorescent layer 23G to be incident into the color filter layer 622.

The bluish light that has passed through the visible light reflecting layer 624 passes through the first transparent layer 23T.

The color filter layer 622 includes a red color filter layer 22R, a green color filter layer 22G, and a second transparent layer 22T. Each of the red and green color filter layers 22R and 22G and the second transparent layer 22T is formed in respective pixel regions. The red and green color filter layers 22R and 22G block the bluish light that has passed through the color fluorescent layer 623.

In FIG. 11, the first transparent layer 23T is different from the second transparent layer 22T. Alternatively, the first transparent layer 23T may be integrally formed with the second transparent layer 22T during the formation of the color fluorescent layer 623.

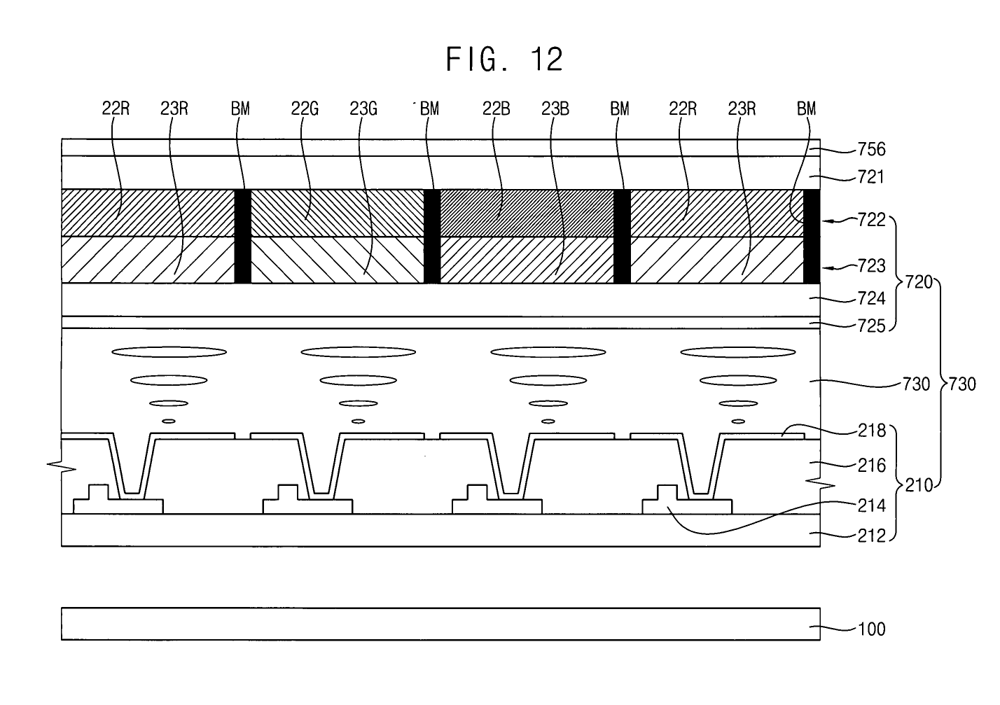

FIG. 12 is a cross-sectional view showing a PLLCD device in accordance with another embodiment of the present invention. The PLLCD device includes a light source generating an ultraviolet light and an anti-glare layer.

Referring to FIG. 12, the PLLCD includes a light source 100 and a fluorescent panel 700. The fluorescent panel 700 displays images using light generated by the light source 100.

The light source 100 supplies the fluorescent panel 700 with ultraviolet light. A wavelength of the ultraviolet light is about 200 nm to about 400 nm.

The fluorescent panel 700 includes an array substrate 210, an opposing substrate 720, and a liquid crystal layer 730. The liquid crystal layer 730 is interposed between the array substrate 210 and the opposing substrate 720. The fluorescent panel 700 displays images using the ultraviolet light generated from the light source 100. The array substrate 210 of FIG. 12 is substantially the same as in FIG. 1. Thus, the same reference numerals will be used to refer to the same or like parts as those described in FIG. 1 and any further explanation concerning the above elements will be omitted.

The opposing substrate 720 includes a second transparent substrate 721, a color filter layer 722, a color fluorescent layer 723, a visible light reflecting layer 724, a common electrode layer 725, and an anti-glare layer 726. The color filter layer 722 is provided on the second transparent substrate 721. The color fluorescent layer 723 is provided on the color filter layer 722. The visible light reflecting layer 724 is provided on the color fluorescent layer 723. The common electrode layer 725 is provided on the visible light reflecting layer 724. The anti-glare layer 726 is provided on the common electrode layer 725.

A common voltage that is provided from outside of the fluorescent panel 700 is applied to the common electrode layer 725. The common electrode layer 725 is transparent.

The visible light reflecting layer 724 transmits ultraviolet light that has passed through the liquid crystal layer 730. Visible light generated by the color fluorescent layer 723 is reflected from the visible light reflecting layer 724.

The color fluorescent layer 723 includes a red fluorescent layer 23R, a green fluorescent layer 23G, and a blue fluorescent layer 23B. Each of the red, green, and blue fluorescent layers 23R, 23G, and 23B is formed in a pixel region. The color fluorescent layer 723 is formed on the visible light reflecting layer 724. The pixel region are defined by a black matrix BM. The color fluorescent layer 723 is excited by the ultraviolet light that has passed through the visible light reflecting layer 724. The excitation of the color fluorescent layer 723 causes the color fluorescent layer 723 to generate visible light. Visible light that is directed towards the visible light reflecting layer 724 is reflected from the visible light reflecting layer 724 and passes through the color fluorescent layer 723.

In particular, the red fluorescent layer 23R is excited by the ultraviolet light that has passed through the visible light reflecting layer 724 to generate red light. A portion of the red light that is reflected from the visible light reflecting layer 724 passes through the red fluorescent layer 23R to be incident into the color filter layer 722.

The green fluorescent layer 23G is excited by the ultraviolet light that has passed through the visible light reflecting layer 724 to generate green light. A portion of the green light that is reflected from the visible light reflecting layer 724 passes through the green fluorescent layer 23G to be incident into the color filter layer 722.

The blue fluorescent layer 23B is excited by the ultraviolet light that has passed through the visible light reflecting layer 724 to generate blue light. A portion of the blue light that is reflected from the visible light reflecting layer 724 passes through the blue fluorescent layer 23B to be incident into the color filter layer 722.

The color filter layer 722 includes a red color filter layer 22R, a green color filter layer 22G, and a blue color filter layer 22B. Each of the red, green, and blue color filter layers 22R, 22G, and 22B are provided in respective pixel regions. The color filter layer 722 also blocks the ultraviolet light that has passed through the color fluorescent layer 723.

The anti-glare layer 726 has a haze surface. The anti-glare layer 726 may comprise a plurality of resin layers having haze values H of about 12%, 25%, 44%, etc.

In accordance with the present invention, the visible light reflecting layer is formed between the liquid crystal layer and the color fluorescent layer to transmit the ultraviolet light or the bluish light generated by the light source and to reflect the visible light that is generated by the color fluorescent layer. The reflected visible light is recycled to pass through the color fluorescent layer toward the front of the fluorescent panel. The molecules of the color fluorescent layer are excited by the ultraviolet light or the bluish light that has passed through the liquid crystal layer to generate visible light, and the color fluorescent layer transmits the visible light that is reflected from the visible light reflecting layer.

Therefore, images are displayed using the visible light generated from the color fluorescent layer and the visible light reflected from the visible light reflecting layer, thereby increasing the luminance of the display device and decreasing power consumption of the display device.

This invention has been described with reference to the embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A display device comprising:
a visible light reflecting layer transmitting invisible light and reflecting visible light; and
a fluorescent layer on the visible light reflecting layer for generating visible light in response to absorption of invisible light that has passed through the visible light reflecting layer, the fluorescent layer transmitting the visible light reflected from the visible light reflecting layer.

2. The display panel of claim 1, further comprising a liquid crystal layer, said visible light reflecting layer being provided between the liquid crystal layer and the fluorescent layer.

3. The display device of claim 2, further comprising a transparent substrate interposed between the liquid crystal layer and the visible light reflecting layer.

4. The display device of claim 3, further comprising a common electrode layer on the transparent substrate.

5. The display device of claim 3, wherein the transparent substrate comprises a glass substrate or a plastic substrate.

6. The display device of claim 1, further comprising a color filter layer on the fluorescent layer to block a portion of a bluish light which has passed through the fluorescent layer or an excitation light that is provided from outside of the fluorescent panel.

7. The display device of claim 6, further comprising a transparent substrate covering the color filter layer.

8. The display device of claim 7, further comprising a common electrode layer on the visible light reflecting layer.

9. The display device of claim 7, wherein the transparent substrate comprises a glass substrate or a plastic substrate.

10. The display device of claim 1, wherein the visible light reflecting layer comprises a multi-layered structure having various refractive indices.

11. The display device of claim 2, wherein the visible light reflecting layer comprises a cholesteric liquid crystal and a vertically aligned liquid crystal.

12. A display device comprising:
a light source;
a visible light reflecting layer for transmitting invisible light and reflecting visible light; and
a fluorescent layer on the visible light reflecting layer for generating visible light in response to absorption of invisible light that has passed through the visible light reflecting layer, the fluorescent layer transmitting the visible light reflected from the visible light reflecting layer, wherein said visible light reflecting layer is positioned between the fluorescent layer and the light source.

13. The display device of claim 12, further comprising a liquid crystal layer between the light source and the visible light reflecting layer.

14. The display device of claim 12, wherein the light source generates light having a wavelength of about 350 nm to about 450 nm.

15. The display device of claim 12, wherein the light source generates a bluish light.

16. The display device of claim 15, wherein:
the visible light reflecting layer comprises a first region, a second region, and a third region; and
the fluorescent layer comprises a red fluorescent layer in the first region and a green fluorescent layer in the second region.

17. The display device of claim 16, wherein a first transparent layer is in the third region.

18. The display device of claim 16, further comprising a color filter layer on the fluorescent layer to block a portion of a bluish light which has passed through the fluorescent layer or an excitation light that is provided from an outside of the fluorescent panel, the color filter layer comprising a red color filter layer in the first region and a green color filter layer in the second region.

19. The display device of claim 18, wherein the color filter layer further comprises a second transparent layer in the third region.

20. The display device of claim 12, wherein the light source generates an ultraviolet light.

21. The display device of claim 20, wherein the visible light reflecting layer comprises a first region, a second region and a third region, and the fluorescent layer comprises a red fluorescent layer in the first region, a green fluorescent layer in the second region and a blue fluorescent layer in the third region.

22. The display device of claim 21, further comprising a color filter layer on the fluorescent layer to block a portion of an excitation light which has passed through the fluorescent layer, the color filter layer comprising a red color filter, a green color filter and a blue color filter.

23. The display device of claim 12, further comprising an anti-glare layer on the fluorescent layer.

24. A display device comprising:
a light source;
a first substrate on the light source;
a second substrate corresponding to the first substrate;
a visible light reflecting layer on the second substrate for transmitting invisible light and reflecting visible light; and
a color fluorescent layer on the visible light reflecting layer for generating visible light in response to absorption of invisible light that has passed through the visible light reflecting layer, the color fluorescent layer transmitting the visible light reflected from the visible light reflecting layer.

25. The display device of claim 24, further comprising a liquid crystal layer between the first and second substrates.

26. The display device of claim 24, further comprising a color filter layer on the color fluorescent layer to block a portion of a bluish light which has passed through the color fluorescent layer and an excitation light that is provided from an outside of the display device.

27. A display device comprising:
a light source;
a first substrate on the light source;
a second substrate on the first substrate;
a visible light reflecting layer between the liquid crystal layer and the second substrate, said visible light reflecting layer transmitting invisible light and reflecting visible light; and
a color fluorescent layer between the visible light reflecting layer and the second substrate for generating visible light in response to absorption of invisible light that has passed through the visible light reflecting layer, the color fluorescent layer transmitting visible light reflected from the visible light reflecting layer.

28. The display device of claim 27, further comprising a liquid crystal layer between the first and second substrates.

29. The display device of claim 27, further comprising a color filter layer between the second substrate and the color fluorescent layer to block a portion of a bluish light which has passed through the color fluorescent layer and an excitation light that is provided from an outside of the display device.
